(19) United States
(12) Patent Application Publication
(10) Pub. No.: US 2012/0260784 A1
(43) Pub. Date: Oct. 18, 2012

(54) PRESS WORKING METHOD AND PRESS WORKING APPARATUS

(75) Inventors: Kazuya SAITO, Hagagun (JP); Kohei TESHIMA, Hagagun (JP); Toshifumi MATSUDA, Hagagun (JP); Jiro WATANABE, Hagagun (JP); Hiroyuki EGUCHI, Hagagun (JP)

(73) Assignee: HONDA MOTOR CO., LTD., Tokyo (JP)

(21) Appl. No.: 13/438,393

(22) Filed: Apr. 3, 2012

(30) Foreign Application Priority Data
Apr. 14, 2011 (JP) 2011-089675

(51) Int. Cl. B26F 1/02; B26F 1/14; B26D 5/08; B21D 31/00

(52) U.S. Cl. 83/15; 72/332; 83/684; 83/359; 83/523

(57) ABSTRACT

A press working method for processing a heated workpiece includes a punching process of punching the heated workpiece using a working tool in a state of urging the workpiece by a pad, a retreating process of retreating the working tool from the punched workpiece, and a holding process of holding the punched workpiece in a state of being urged by the pad after the retreating process.

### BACKGROUND OF THE INVENTION

1. Field of the Invention

The present invention relates to a press working method and a press working apparatus for processing a heated workpiece.

2. Related Art

Conventionally, a press working method in which a heated workpiece is press-worked and then subjected to a quenching process is known. Since a processed product obtained by such a working method has a high strength owing to the quenching process, it is difficult to perform a punching process (piercing process) or a cutting process by a working tool. The punching process or the cutting process of the processed product can be performed by a laser processing. However, in this case, there is a problem that a manufacturing cost is raised, as compared to a case of utilizing the working tool.

As a press working method for solving the above problem, JP-A-2005-138111 discloses a method in which a heated workpiece is punched by a working tool (movable mold) while being press-worked by a pad (punch), and then a quenching process is completed. According to this method, the workpiece can be subjected to a punching process before it has a high strength by the quenching process. Accordingly, it is possible to easily perform the punching process for the workpiece.

However, in the method of JP-A-2005-138111, when the workpiece is subjected to the quenching process in a state where the working tool remains in a punched portion of the workpiece, that is, in a state where the working tool is not yet retreated from the workpiece, the working tool is dragged with the workpiece due to a retraction of the workpiece and thus it is difficult to take out the working tool from the workpiece. Consequently, there is a risk that the working tool or the workpiece can be damaged.

### SUMMARY OF THE INVENTION

One or more embodiments relates to a press working method and a press working apparatus which can prevent a working tool from being dragged with a workpiece even in a case of punching a heated workpiece to suitably suppress a damage of the workpiece and the working tool, thereby obtaining an excellent processed product with good quality.

### BRIEF DESCRIPTION OF THE DRAWINGS

FIG. 1 is a sectional view for explaining a press working apparatus according to a first embodiment.

FIG. 2 is a flow chart for explaining a press working method using the press working apparatus illustrated in FIG. 1.

FIG. 3 is a graph illustrating temperature changes of a workpiece during a press working.

FIG. 4 is a sectional view for explaining the press working apparatus in a state where a first press working is performed.

FIG. 5 is a sectional view for explaining the press working apparatus in a state where a second press working is performed.

FIG. 6 is a sectional view for explaining the press working apparatus in a state where a working tool is retreated from a second processed workpiece.

FIG. 7 is a sectional view for explaining a state where a second press working is performed using a press working apparatus according to a second embodiment.

FIG. 8 is a sectional view illustrating the press working apparatus of FIG. 7 in a state where the working tool is retreated from the second processed workpiece.

FIG. 9 is a sectional view for explaining a state where a second press working is performed using a press working apparatus according to a third embodiment.

FIG. 10 is a sectional view illustrating the press working apparatus of FIG. 9 in a state where the working tool is retreated from the second processed workpiece.

### DETAILED DESCRIPTION OF THE EMBODIMENTS

Hereinafter, a press working method and a press working apparatus according to embodiments will be described with reference to accompanying drawings. The embodiments described herein are not intended to limit the invention but only examples of the invention, and all features or combinations of the features of the embodiments are not always essential to the invention.

### First Embodiment

First, a press working apparatus 10A according to a first embodiment will be described. In the press working apparatus 10A of the present embodiment, a metal plate W (workpiece) is subjected to a first press working and then a further (second) press working (punching processing, piercing processing), and then the workpiece W is cooled to a predetermined temperature. Meanwhile, hereinafter, the workpiece W subjected to a first press working is referred to a first processed workpiece W1 and the workpiece W subjected to a second press working is referred to a second processed workpiece W2.

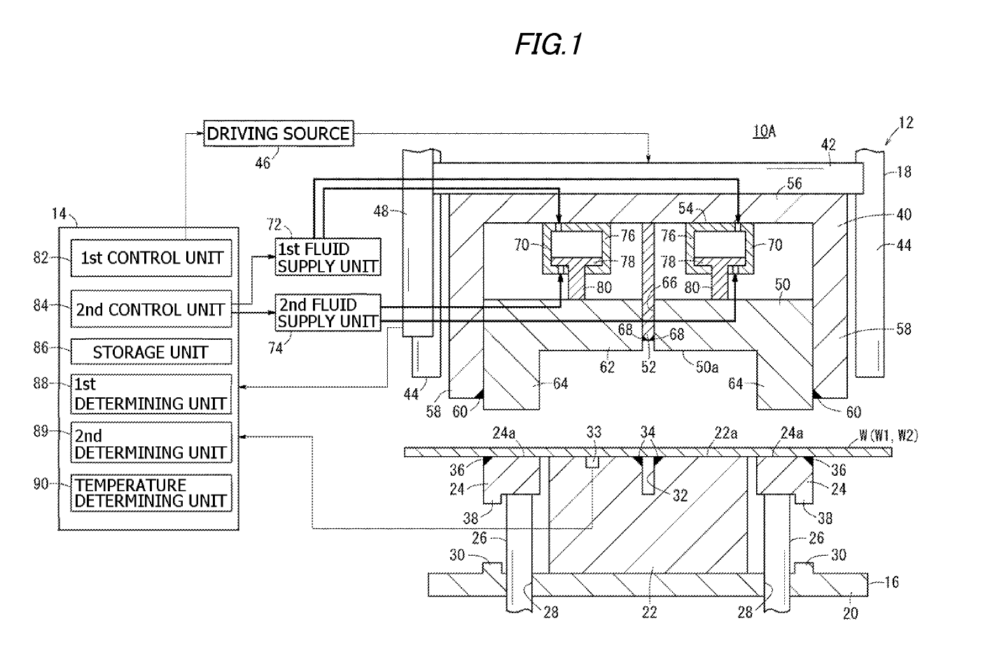

As illustrated in FIG. 1, the press working apparatus 10A includes an apparatus main body 12 for processing the workpiece W (first processed workpiece W1) and a control unit 14 for controlling the apparatus main body 12.

The apparatus main body 12 includes a first mechanism 16 and a second mechanism 18 which is opposed to the first mechanism 16. The first mechanism 16 have a fixed base 20 as a base, a male punching part 22 provided on the fixed base 20, an annular blank holder 24 arranged outside the punching part 22 and supporting a part of the workpiece W, and a plurality (two pins are illustrated in drawings) of pins 26, 26 fixed to the blank holder 24.

The fixed base 20 is provided with a plurality of through holes 28, 28 through which the plurality of pins 26, 26 are inserted. Further, a region of the fixed base 20 opposed to the blank holder 24 is provided with a pair of protrusions 30, 30.

The punching part 22 performs a press working for the workpiece W while holding the workpiece W together with a die part 50 (which will be described later) constituting the second mechanism 18. The punching part 22 is provided at its outer surface with a punching surface 22a which is adapted to contact one surface of the workpiece W. The punching surface 22a is formed with a relief hole 32 through which a working tool 52 (which will be described later) can be inserted. The relief hole 32 is provided at its edge with a cutting blade 34. Meanwhile, a temperature detector 33 for detecting the temperature of the second processed workpiece W2 is embedded in the punching surface 22a. Herein, the temperature detector 33 may detect the temperature of the punching part 22 and estimate the temperature of the second processed workpiece W2 from the detected temperature of the punching part.

The plurality of pins 26, 26 fixed to the blank holder 24 are connected to a moving mechanism (not illustrated) and the blank holder 24 is adapted to move in the extending direction of the pins 26, 26 by the action of the moving mechanism. The blank holder 24 has a placing surface 24a on which the workpiece W is placed. The placing surface 24a is provided at its outer edge with a cutting blade 36. A back surface of the blank holder 24 is provided with a pair of stoppers 38, 38 which are adapted to contact the protrusions 30, 30 mentioned above.

The second mechanism 18 includes a slider 42, a pair of rails 44, 44 for retractably guiding the slider 42 relative to the punching part 22 (workpiece W), a driving source 46 (base part driving unit) for retractably driving the slider 42, a linear sensor (positional information acquisition unit) 48 for outputting a signal corresponding to a position of the slider 42 in an advance and retreat direction, a base part 40 provided on the slider 42, a female die part 50 (pad) supported on the base part 40 via a cylinder mechanism 54 (connecting unit), and a working tool 52 provided on the base part 40.

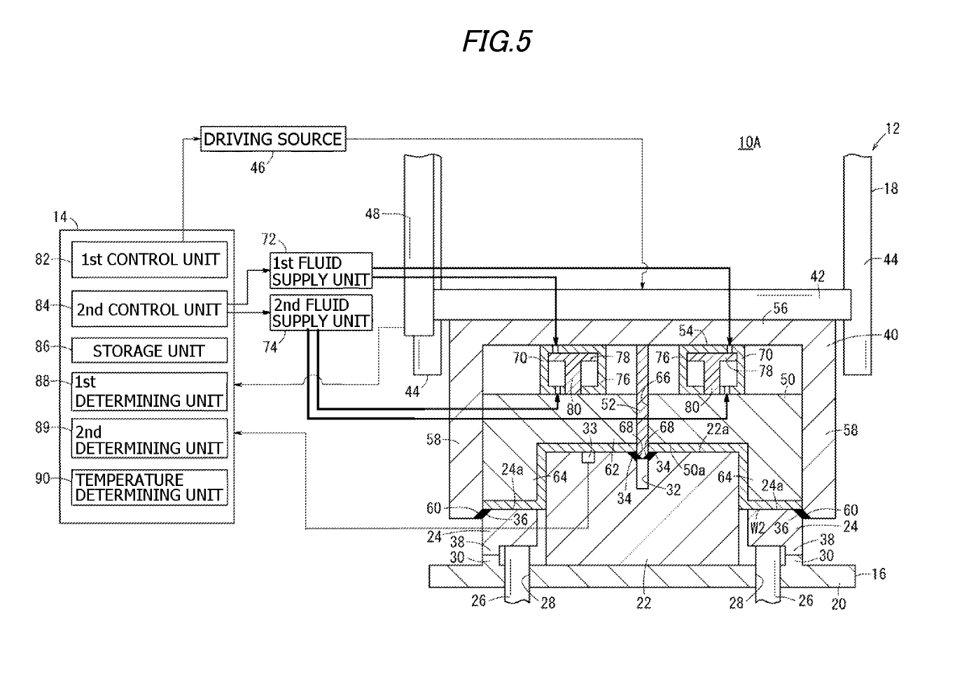

The base part 40 includes a plate-like fixed portion 56 fixed to the slider 42 and a cylindrical extending portion 58 extending from an edge of the fixed portion 56 to a side of the die part 50. One end surface of the extending portion 58 is provided at its inner edge with a cutting blade 60. Unnecessary portions of the workpiece W are cut away by the cutting blade 60 and the above cutting blade 36 provided on the blank holder 24 (see FIG. 5).

The die part 50 is accommodated in a space inside the extending portion 58. Thereby, the press working apparatus 10A can be formed in more compact manner, as compared to a case where the die part 50 is arranged at a region other than the space. The die part 50 performs a press working for the workpiece W while holding the workpiece W together with the punching part 22 constituting the first mechanism 16. The die part 50 includes a thick die main body 62 formed in the form of a plate and an annular holder portion 64 projecting from an edge of the die main body 62 to a side of the blank holder 24.

The die main body 62 is formed with a through hole 66 through which the working tool 52 passes. One surface of the die main body 62 is terminated at an inner surface of the holder portion 64. And, a punching surface 50a adapted to contact one surface of the workpiece W is formed by the one surface of the die main body 62 and the inner surface of the holder portion 64. This punching surface 50 is formed in a shape corresponding to the shape of the punching surface 22a.

When the workpiece W is press-worked, the holder portion 64 holds the workpiece W together with the blank holder 24 to prevent a wrinkle or a positional offset from occurring. Accordingly, an end surface of the holder portion 64 is adapted to contact the workpiece W ahead of the punching surface 50a. Meanwhile, an outer surface of the holder portion 64 is in sliding contact with the inner surface of the extending portion 58. Thereby, when the base part 40 and the die part 50 are moved relative to each other, the shaking of the extending portion 58 can be suitably prevented. Accordingly, it is possible to improve the cutting precision of the cutting blade 60 of the extending portion 58 for the first processed workpiece W.

For example, the working tool 52 is made from a tool steel and formed in a columnar shape. One end surface of the working tool 52 is provided at its edge with a cutting blade 68. A punching process can be performed by the cutting blade 68 and the cutting blade 34 provided on the punching part 22 (see FIG. 5). Other end surface of the working tool 52 is fixed to one surface of the fixed portion 56.

The cylinder mechanism 54 includes a pair of cylinder units 70, 70, and a first fluid supply unit 72 and a second fluid supply unit 74 for supplying a fluid to respective cylinder unit 70.

For example, each of the cylinder units 70 is configured as a hydraulic cylinder and includes a cylinder main body 76 fixed to one surface of the fixed portion 56, a piston 78 accommodated in the cylinder main body 76 to move in an advance and retreat direction of the die part 50, and a rod portion 80 integrally formed with the piston 78 and fixed to other surface of the die main body 62.

The first fluid supply unit 72 supplies a fluid in the cylinder main body 76 of each cylinder unit 70 to bias the piston 78 toward the rod portion 80. Meanwhile, the second fluid supply unit 74 supplies a fluid in the cylinder main body 76 of each cylinder unit 70 to bias the piston 78 toward the fixed portion 56.

The control unit 14 includes a first control unit 82 (base part driving control unit), a second control unit 84 (control unit), a storage unit 86, a first determining unit 88, a second determining unit 89 and a temperature determining unit 90.

The first control unit 82 controls the driving source 46 to cause the slider 42 to retractably move relative to the punching part 22 (workpiece W). The second control unit 84 controls the first fluid supply unit 72 and the second fluid supply unit 74.

A preset press working data is stored in the storage unit 86. As the press working data, a press pressure, a holding pressure, a first cylinder pressure, a second cylinder pressure, a pressure cooling temperature T0, a first slider position data and a second slider position data, etc., are utilized.

Herein, the press pressure refers to a pressing pressure which is applied on the workpiece (or first processed workpiece W1) during the first press working.

Herein, the holding pressure refers to a pressing pressure which is applied on the second processed workpiece W2 in a holding process (which will be described later). In this case, the holding pressure may be same as the press pressure.

Herein, the first cylinder pressure refers to a pressure of a fluid which is supplied from the first fluid supply unit 72 to the second fluid supply unit 74 when the first press working is performed and after the second press working is completed. The first cylinder pressure is set higher than the press pressure and the holding pressure.

Herein, the second cylinder pressure refers to a pressure of a fluid which is supplied from the first fluid supply unit 72 to the cylinder main body 76 when the second press working is performed. The second cylinder pressure is set lower than the press pressure.

Herein, the pressure cooling temperature T0 refers to a cooling temperature T0 of the second processed workpiece W2 in a state where the holding pressure is applied on the second processed workpiece W2.

Herein, the first slider position data refers to a data corresponding to a signal outputted from the linear sensor 48 when the first press working is completed.

Herein, the second slider position data refers to a data corresponding to a signal outputted from the linear sensor 48 when the second press working is completed. Meanwhile, when the second press working is completed, the cutting blade 68 provided on the working tool 52 passes through the second processed workpiece W2 and is positioned in the relief hole 32.

The press working data can be set in accordance with a material quality, a plate thickness and a size of the workpiece.

The first determining unit 88 determines whether the output signal from the linear sensor 48 coincides with the first slider position data or not. The second determining unit 89 determines whether the output signal from the linear sensor 48 coincides with the second slider position data or not.

The temperature determining unit 90 determines whether the temperature of the second processed workpiece W2 detected by the temperature detector 33 is lowered to the pressure cooling temperature T0 or not.

Next, a method for processing the workpiece W using the press working apparatus 10A thus configured will be described by referring to FIGS. 1 to 6.

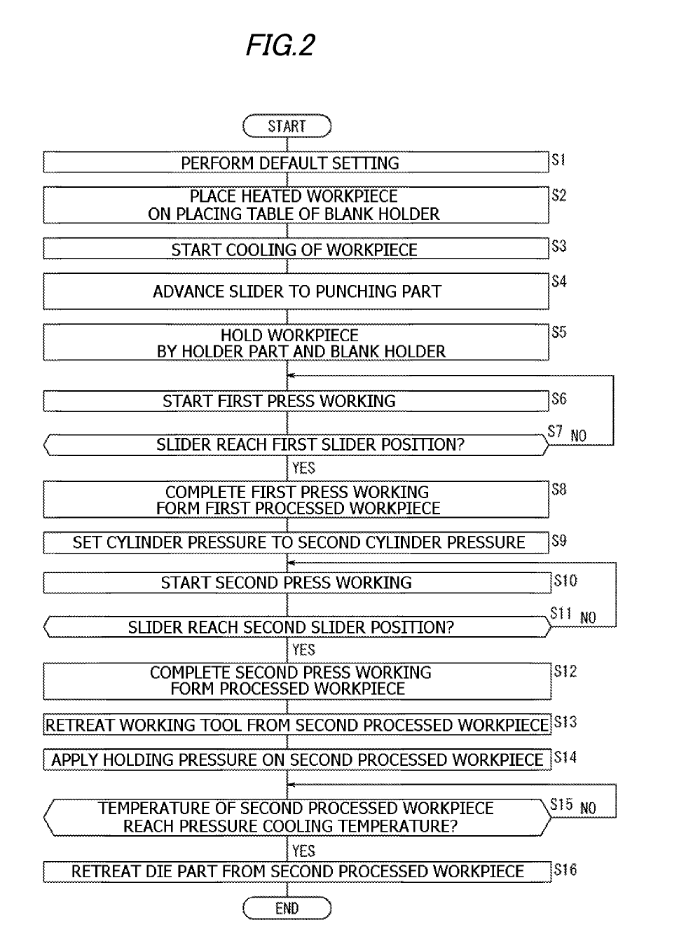

First, a default setting is performed (Step S1 of FIG. 2). Specifically, the blank holder 24 and the slider 42 are set to an initial position (a state illustrated in FIG. 1) and the second control unit 84 controls the first fluid supply unit 72 to set the pressure in the cylinder main bodies 76, 76 as the first cylinder pressure. Meanwhile, a fluid is not supplied from the second fluid supply unit 74 to the cylinder main bodies 76, 76. However, a fluid having a pressure lower than the first cylinder pressure may be supplied from the second fluid supply unit 74 to the cylinder main bodies 76, 76. By doing so, it is possible to reduce a load of the cylinder units 70, 70 due to an own weight of the die part 50.

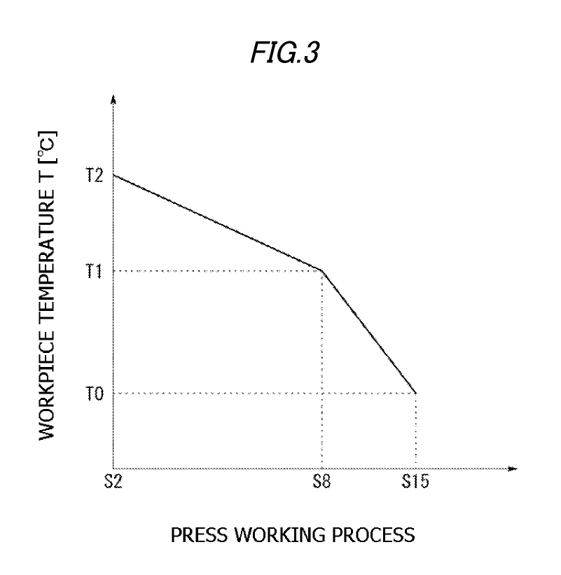

Subsequently, an unprocessed workpiece W which is heated to a predetermined temperature T2 (see FIG. 3) for example in a heating furnace in the previous process is placed on the placing surface 24a of the blank holder 24 (Step 2).

At this time, as the workpiece W and the mold are in contact with each other, the cooling of the workpiece W is started (Step 3). Actually, since the cooling of the workpiece W is stared after the workpiece is taken out from the heating furnace, the temperature T of the workpiece W is slightly lower than the temperature T2 in the step of placing the workpiece W on the placing surface 24a of the blank holder 24.

And then, the first control unit 82 controls the driving source 46 to cause the slider 42 to advance toward the punching part 22 (Step S4). By doing so, the holder portion 64 is in contact with the other surface of the workpiece W and the workpiece W is held by the holder portion 64 and the blank holder 24 (Step S5). As the slider 42 further advances, the blank holder 24 is urged by the holder portion 64 and moves toward the fixed base 20, and thus the workpiece W is gradually pressed in a desired shape by the blank holder 24 and the punching part 22 (Step S6).

At this time, the first determining unit 88 determines whether the output signal from the linear sensor 48 coincides with the first slider position data or not (Step S7). When it is determined that the output signal does not coincide with the first slider position data (NO in Step S7), the first press working is continuously performed. This is because the first press working is not yet completed.

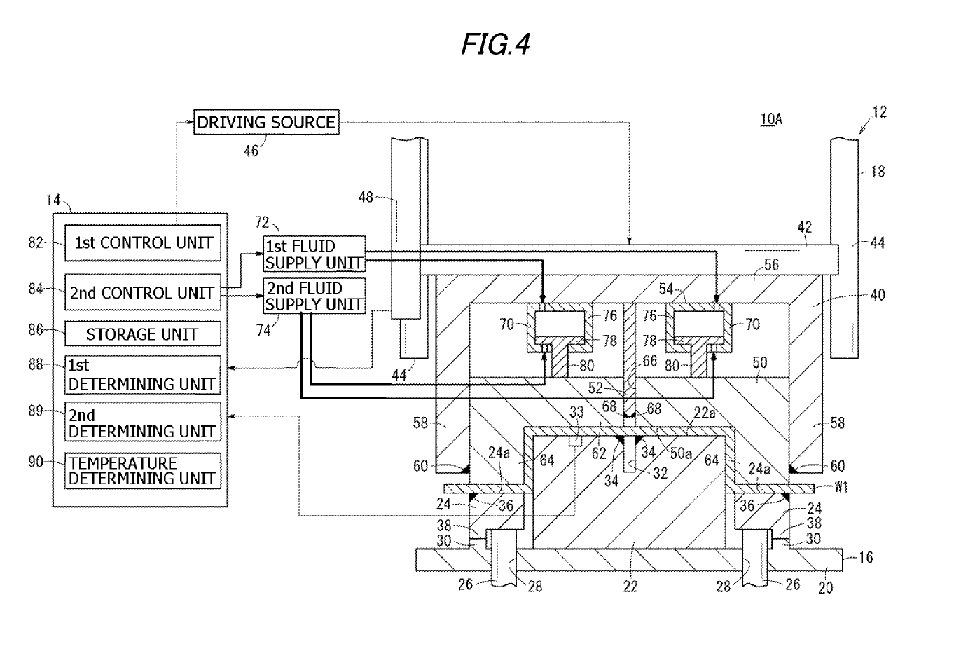

When it is determined that the output signal coincides with the first slider position data (YES in Step S7), the first press working is completed and the first processed workpiece W1 is formed (Step S8: see FIG. 4). At this time, the first control unit 82 causes the first processed workpiece W1 to be pressed until an urging pressure applied on the first processed workpiece W1 reaches the press pressure stored in the storage unit 86. By doing so, deformation of the first processed workpiece W1 due to a thermal strain is suppressed. Meanwhile, as is appreciated from FIG. 4, at this time, the stoppers 38, 38 of the blank holder 24 are in contact with the protrusions 30, 30 of the fixed base 20.

Further, in Step S8, the temperature T of the first processed workpiece W1 is lowered to the temperature T1 and the first processed workpiece W1 is in contact with the punching part 22 and the die part 50. Thereby, a heat of the first processed workpiece W1 is diffused (dissipated) to the punching part 22 and the die part 50 and therefore a cooling speed of the first processed workpiece W1 increases from the time of Step S8 (see FIG. 3). Accordingly, the workpiece W can be quenched by adjusting the material quality of the punching part 22 and/or the die part 50 or the contact area thereof with the workpiece W (the first processed workpiece W1).

Subsequently, the second control unit 84 controls the first fluid supply unit 72 to set the pressure in the cylinder main bodies 76, 76 as the second cylinder pressure (Step S9). By doing so, since the pressure of the fluid supplied from the first fluid supply unit 72 to the cylinder main body 76 becomes lower than the press pressure, the base part 40 is displaced toward the fixed base 20 relative to the die part 50. In other words, the cylinder main bodies 76, 76 are contracted (see FIG. 5). As a result, the punching process for punching the first processed workpiece W1 is started by the cutting blade 68 of the working tool 52 and the cutting blade 34 of the punching part 22, and excessive portions of the first processed workpiece W1 are cut away by the cutting blade 60 of the extending portion 58 and the cutting blade 36 of the blank holder 24 (Step S10).

At this time, the second determining unit 89 determines whether the output signal from the linear sensor 48 coincides with the second slider position data or not (Step S11). When it is determined that the output signal does not coincide with the second slider position data (NO in Step S11), the second press working is continuously performed. This is because the second press working is not yet completed.

When it is determined that the output signal coincides with the second slider position data (YES in Step S11), the second press working is completed and the second processed workpiece W2 is formed (Step S12).

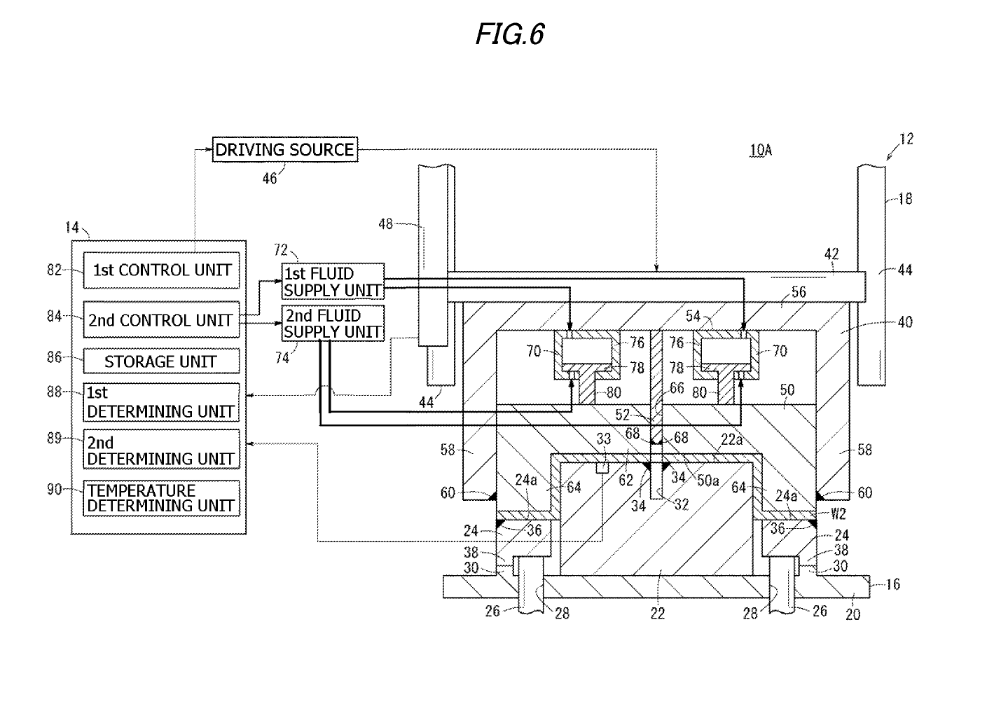

Further, when it is determined by the second determining unit 89 that the slider 42 reaches the second slider position, the second processed workpiece W2 is retreated from the working tool 52 (Step S13: see FIG. 6). Specifically, the second control unit 84 controls the first fluid supply unit 72 to set the pressure in the cylinder main bodies 76, 76 as the first cylinder pressure. By doing so, the base part 40 moves toward the slider 42 relative to the die part 50 by a stroke of the pistons 78, 78 (that is, the cylinder units 70, 70 expand) and therefore the working tool 52 is retreated from the second processed workpiece W2 while the second processed workpiece W2 is urged by the die part 50.

Meanwhile, in this Step S13, the working tool 52 may be retreated from the second processed workpiece W2 based on the control signal which is outputted from the first control unit 82 to the driving source 46. Also in this case, it is possible to easily confirm the time when the second press working is completed using the control signal.

Subsequently, the first control unit 82 controls the driving source 46 to cause the holding pressure to be applied on the second processed workpiece W2 (Step 14: holding process). In this way, the holding process for applying the holding pressure on the second processed workpiece W2 is performed and thus deformation of the second processed workpiece W2 due to a thermal strain can be suppressed.

And, the temperature determining unit 90 determines whether the temperature of the second processed workpiece W2 detected by the temperature detector 33 is lowered to the pressure cooling temperature T0 stored in the storage unit 86 or not (Step S15). When it is determined that the temperature of the second processed workpiece W2 is not yet reached at the pressure cooling temperature T0, Step S14 is continuously performed.

When it is determined that the temperature of the second processed workpiece W2 reaches the pressure cooling temperature T0 (YES in Step S15), the first control unit 82 controls the driving source 46 to cause the die part 50 to be retreated from the second processed workpiece W2 (Step S16). In this step, the press working using the press working apparatus 10A according to the present embodiment is completed.

In this embodiment, since the working tool 52 is retreated from the second processed workpiece W2 before the second processed workpiece W2 is cooled to the predetermined temperature (for example, the pressure cooling temperature T0), it is possible to prevent the working tool 52 from being dragged with the second processing workpiece even if the second processed workpiece W2 is retracted in the holding process. By doing so, the damage of the working tool 52 and the second processed workpiece W2 can be suitably avoided, thereby obtaining a processed product with good quality.

Further, as mentioned above, after the working tool 52 is retreated from the second processed workpiece W2, the second processed workpiece W2 is cooled to the pressure cooling temperature T0 (the holding process is performed) in a state where the holding pressure is applied on the second processed workpiece W2 by the die part 50. Accordingly, deformation of the second processed workpiece W2 due to a thermal strain can be securely suppressed, thereby obtaining a processed product with better quality.

Meanwhile, if the second processed workpiece W2 is quenched at the holding process, the processed product with high strength can be obtained. However, such a quenching may be omitted depending on the specification of the processed product.

Further, since the working tool 52 is retreated from the second processed workpiece W2 when the slider 42 reaches the second slider position, in other words, the second press working (punching processing) is completed, it is possible to securely prevent the working tool 52 from being dragged with the second processed workpiece W2.

In this embodiment, since the first processed workpiece W1 is securely urged by the die part 50 at the first press working, it is possible to securely prevent a positional offset of the first processed workpiece W1 at the second press working. Thereby, the punching processing precision can be increased.

The press working apparatus 10A is not limited to the above configuration. For example, as the connecting unit, a driving source (piezo element) other than the cylinder mechanism 54 mentioned above or an elastic member such as a spring member may be used. In this embodiment, when the spring member is used as the connecting unit, for example, a pair of spring members are provided, instead of the cylinder units 70, 70 and the first fluid supply unit 72, the second fluid supply unit 74 and the second control unit 84 may be omitted. And, in the Step 13, the first control unit 82 may control the driving source 46 to cause the slider 42 to be retreated by a predetermined distance. By doing so, the working tool 52 can be retreated from the second processed workpiece W2 while the second processed workpiece W2 is urged by the die part 50.

### Second Embodiment

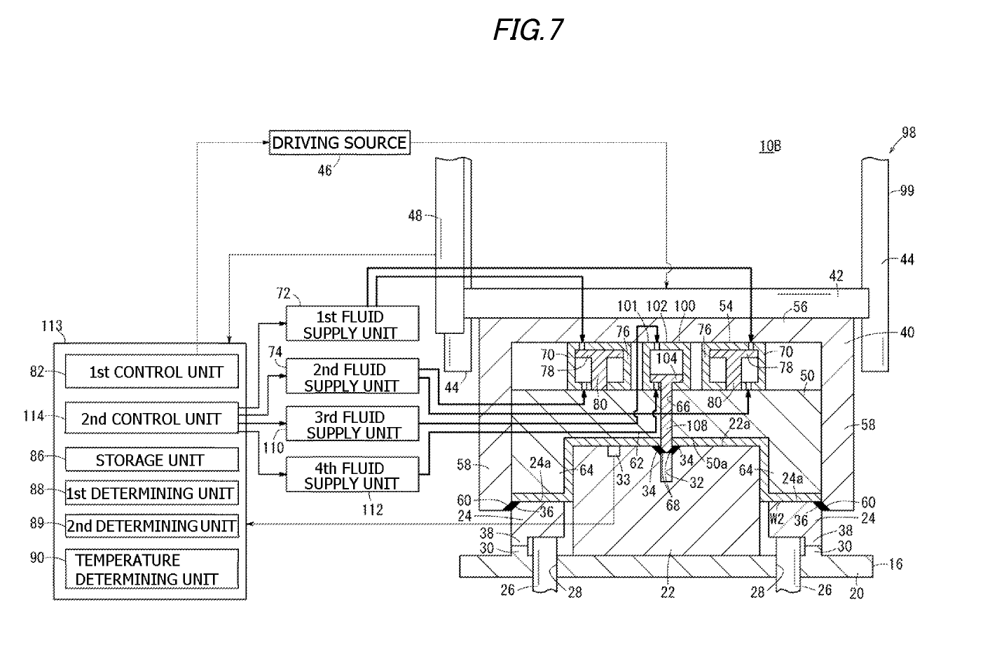

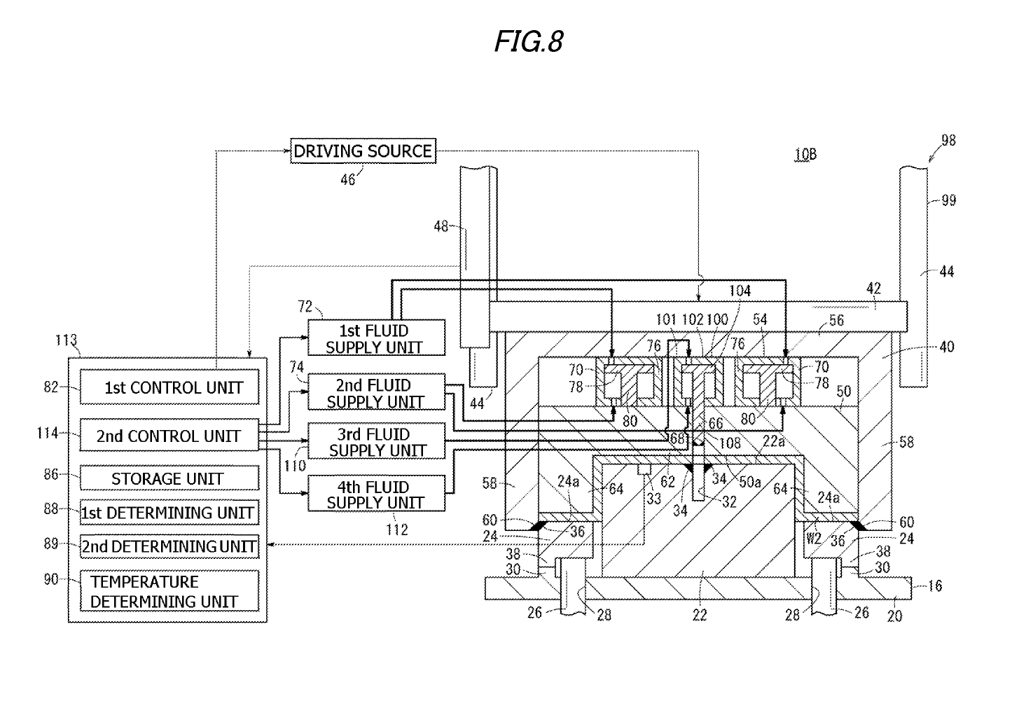

Next, a press working apparatus 10B according to a second embodiment will be described by referring to FIGS. 7 and 8. In this embodiment, the same structural element will be noted by the same reference numeral as that of the first embodiment and the duplicated explanation thereof will be omitted. Meanwhile, FIG. 7 illustrates the press working apparatus in a state where the second press working is completed and FIG. 8 illustrates the press working apparatus in a state where the working tool 108 is retreated from the second processed workpiece W2.

As illustrated in FIG. 7, a processing apparatus main body 98 constituting the press working apparatus 10B according to the present embodiment includes a second mechanism 99 having a configuration different from the second mechanism 18 illustrated in FIG. 1. Specifically, the second mechanism 99 further includes a cylinder mechanism 101 (driving unit).

The cylinder mechanism 101 includes a cylinder unit 100 provided between the working tool 108 and the fixed portion 56, a third fluid supply unit 110 and a fourth fluid supply unit 112. For example, the cylinder unit 100 is configured as a hydraulic cylinder and includes a cylinder main body 102 fixed to one surface of the fixed portion 56 and a piston 104 accommodated in the cylinder main body 102 to move in an advance and retreat direction of the base part 40. The working tool 108 having a cutting blade 68 is integrally provided on one surface of the piston 104. Thereby, the cylinder unit 100 can displace the working tool 108 relative to the die part 50 along an advance and retreat direction of the base part 40 (die part 50).

Meanwhile, the length of the working tool 108 is set shorter than that of the working tool 52 mentioned above. That is, it is difficult to flex the working tool 108 rather than the working tool 52 when working tool 108 and the working tool 52 are made from same material and have same diameter.

Further, the third fluid supply unit 110 supplies a fluid in the cylinder main body 102 to bias the piston 104 toward the working tool 108 and the fourth fluid supply unit 112 supplies a fluid in the cylinder main body 102 to bias the piston 104 toward the fixed portion 56. Meanwhile, the third fluid supply unit 110 and the fourth fluid supply unit 112 are controlled by the second control unit 114 of the control unit 113.

The press working using the press working apparatus 10B according to the present embodiment is basically performed depending on the processing steps of the flow chart illustrated in FIG. 2 but the processing treatment in Step S13 is slightly different from the Step 13 of the flow chart. Specifically, in the Step S13 of the present embodiment, when it is determined by the second determining unit 89 that the slider 42 reaches the second slider position in the Step S11, the second control unit 114 causes the fourth fluid supply unit 112 to supply a fluid in the cylinder main body 102 in a state where the third fluid supply unit 110 does not supply a fluid in the cylinder main body 102, thereby moving the piston 104 toward the fixed portion 56 (see FIG. 8). Thereby, the working tool 108 is displaced (retreated) toward the fixed portion 56 relative to the die part 50 and therefore the working tool 108 can be retreated from the second processed workpiece W2.

As such, in the present embodiment, in a case where the working tool 108 is retreated from the second processed workpiece W2, the working tool 108 can be relatively displaced without driving the cylinder units 70, 70, that is, without displacing the base part 40 toward the slider 40 relative to the die part 50. Accordingly, the press working can be effectively performed.

### Third Embodiment

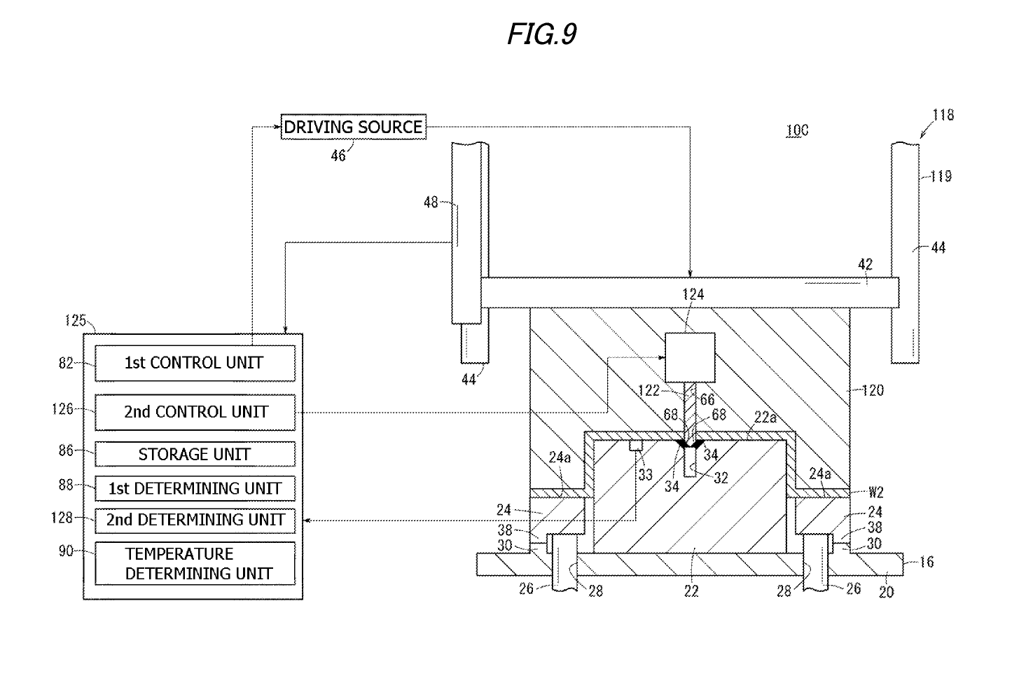

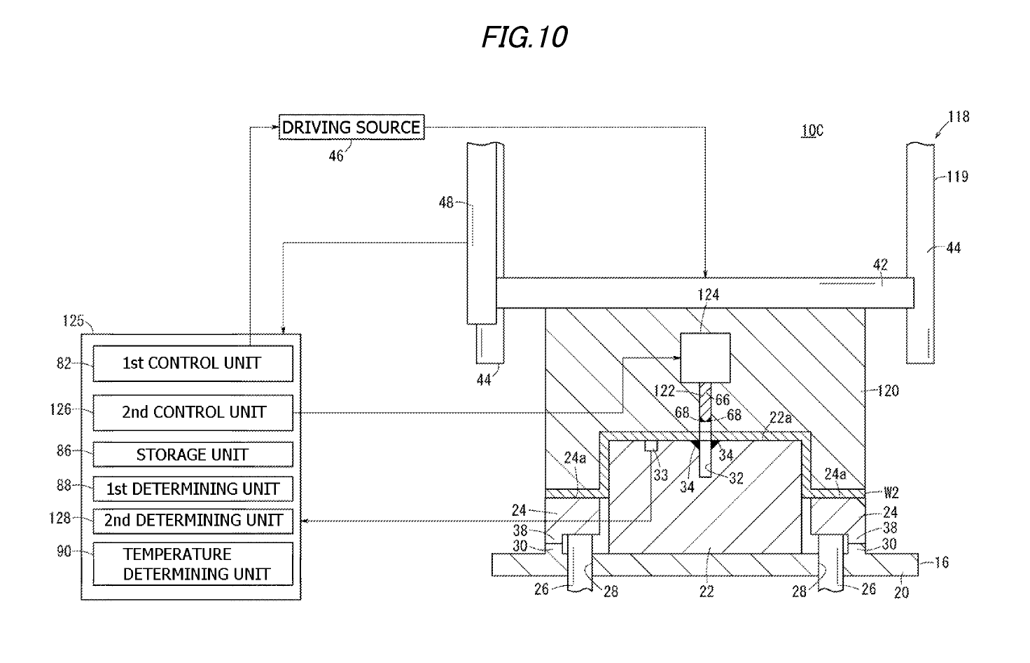

Next, a press working apparatus 10C according to a third embodiment will be described by referring to FIGS. 9 and 10. FIG. 9 illustrates the press working apparatus in a state where the punching processing is performed by a working tool 122 and FIG. 10 illustrates the press working apparatus in a state where the working tool 122 is retreated from the second processed workpiece W2.

As illustrated in FIG. 9, an apparatus main body 118 constituting the press working apparatus 10C according to the present embodiment includes a second mechanism 119 having a configuration different from the second mechanism 18 illustrated in FIG. 1. Specifically, in the second mechanism 119, the base part 40, the cylinder mechanism 54 and the cutting blade 36 of the blank holder 24 are omitted and a thick die part 120 is directly provided on the slider 42. The die part 120 is provided at its inner side with a driving unit 124 (driving unit) which drives the working tool 122 along the advance and retreat direction of the slider 42, thereby displacing the working tool 122 relative to the die part 120. For example, the driving unit 124 is configured as a hydraulic cylinder mechanism and controlled by a second control unit 126 of a control unit 125.

A second determining unit 128 of the control unit 125 determines whether the punching processing is completed or not. Specifically, the second determining unit 128 determines whether the punching processing is completed or not, based on the control signal which is outputted from the second control unit 126 to the driving unit 124. In this case, it is preferred that the second determining unit 128 determines that the punching processing is completed, after a predetermined time lapses from the output time of the control signal. Meanwhile, the predetermined time refers to the time that it takes the cutting blade 68 of the working tool 122 to reach the relief hole 32 from the output time of the control signal and can be measured in advance.

In the press working using the press working apparatus 100 according to the present embodiment, when it is determined by the first determining unit 88 that the first press working is completed, the second control unit 126 controls the driving unit 124 to displace (advance) the working tool 122 toward the fixed base 20 relative to the die part 120, thereby performing the punching processing (second press working). And, when it is determined by the second determining unit 128 that the punching processing is completed, the second control unit 126 causes the working tool 122 to be retreated from the second processed workpiece W2. Meanwhile, after the working tool 122 is retreated from the second processed workpiece W2, the press working is performed according to the processing steps of the flow chart illustrated in FIG. 2.

According to the present embodiment, an effect similar to the effect of the first embodiment can be achieved. Specifically, since the holding process is performed after the working tool 122 is retreated from the second processed workpiece W2, it is possible to prevent the working tool 122 from being dragged with the second processed workpiece even if the second processed workpiece W2 is retracted in the holding process. By doing so, the damage of the working tool 122 and the second processed workpiece W2 can be suitably avoided, thereby obtaining an excellent processed product with good quality. Meanwhile, since the base part 40 is omitted in this embodiment, the punching processing can be performed just by displacing the working tool 122 relative to the die part 120 in the advance and retreat direction of the die part 120.

The present invention is not limited to the above embodiments but can be variously modified without departing from the spirit of the present invention.

For example, a coolant flow path through which a coolant such as a cooling water flows is formed in the blank holder 24 and the punching part 22. In this case, it is possible to further speed up the cooling speed of the second processed workpiece.

The press working method according to the embodiments is also applicable to a case of performing only one process (punching process) for a workpiece.

In accordance with the above described embodiments, a press working method may include: preparing a heated workpiece; punching the heated workpiece using a working tool 52, 108, 122 in a state of urging the workpiece by a pad 50, 120; retreating the working tool 52, 108, 122 from the punched workpiece while keeping the state of urging the workpiece by the pad (50, 120); and holding the punched workpiece from which the working tool is retreated in a state of being urged by the pad 50, 120 after the retreating of the working tool 52, 108, 122.

According to this method, the retreating process is performed before the holding process and therefore it is possible to prevent the working tool from being dragged with the workpiece even if the workpiece is retracted in the holding process. By doing so, the damage of the workpiece and the working tool can be avoided, thereby obtaining an excellent processed product with good quality. Further, the holding process is performed in a state where the workpiece is urged by the pad and thus deformation of the workpiece due to a thermal strain can be suppressed so as to obtain a processed product with better quality. Meanwhile, if the workpiece is quenched in the holding process, a processed product may be significantly enhanced.

The above method may further include: determining whether the punching is completed or not. The working tool 52, 108, 122 may be retreated from the punched workpiece, when it is determined that the punching is completed.

According to this method, since the working tool can be retreated from the workpiece when the punching process is completed, it is possible to securely prevent the working tool from being dragged with the workpiece.

The above method may further include: executing a press working process of pressing the heated workpiece by the pad 50, 120 before the punching.

According to this method, since the heated workpiece is punched after it is pressed by the pad, the workpiece can be firmly urged by the pad at the punching process. By doing so, the positional offset of the workpiece can be further avoided and it is possible to improve the processing precision of the punching process.

The above method may further include: heating the workpiece to a predetermined temperature T2 in the preparing of the heated workpiece; detecting a temperature of the workpiece in the holding of the punched workpiece; and retreating the pad 50, 120 from the held workpiece when the detected temperature of the workpiece is lowered to or below a pressure cooling temperature T0 which is lower than said predetermined temperature T2.

Moreover, in accordance with the above described embodiments, a press working apparatus 10A, 10B in which a heated workpiece is processed may include: a base part 40 configured to move retractably relative to a workpiece; a pad 50 provided separately from the base part 40 and configured to urge the workpiece 50; a working tool 52, 108 provided on the base part 40 and configured to punch the workpiece; and a connecting unit 54 configured to bias the pad 50 toward the workpiece and extend in a telescopic manner along a moving direction of the base part 40 and in which the connecting unit 54 connects the base part 40 and the pad 50 so that the base part 40 and the pad 50 can be displaced relative to each other along the moving direction of the base part 40.

According to this structure, since the working tool provided on the base part can be displaced relative to the pad along the advance and retreat direction of the base part by contracting the connecting unit in a state where the workpiece is urged by the pad, the working tool can punch the workpiece with good precision in a state where the heated workpiece is urged by the pad. Further, since the working tool can be retreated from the workpiece in a state where the workpiece is urged by the pad by expanding the connecting unit, it is possible to prevent the working tool from being dragged with the workpiece. By doing so, the damage of the working tool and the workpiece can be avoided, thereby obtaining an excellent processed product with good quality. Further, since the workpiece can be held in a state of being urged by the pad after the working tool is retreated from the punched workpiece, deformation of the workpiece due to a thermal strain can be suppressed so as to obtain a processed product with better quality. If the workpiece is quenched at this time, a processed product may be significantly enhanced.

The above press working apparatus 10A may further include: a determining unit 89 configured to determine whether a punching operation of the workpiece is completed or not. The press working apparatus 10A may be configured to retreat the working tool 52, 108 from the workpiece in a state where the workpiece is urged by the pad 50 by expanding the connecting unit 54 when it is determined by the determining unit 89 that the punching operation of the workpiece is completed.

According to this structure, since when it is determined by the determining unit that the punching operation of the workpiece is completed, the workpiece can be retreated from the workpiece in a state where the workpiece is urged by the pad by expanding the connecting unit, it is possible to securely prevent the working tool from being dragged with the workpiece.

The above press working apparatus 10A may further include: a base part driving unit 46 configured to drive the base part 40; and a base part driving control unit 82 configured to control the base part driving unit 46. The determining unit 89 may be configured to determine whether the punching operation of the workpiece is completed or not based on a control signal of the base part driving control unit 82.

According to this structure, since the base part and the working tool are driven together in an advance and retreat direction based on the control signal of the base part driving control unit, it is possible to easily confirm the time when the punching operation is completed using the control signal.

The above press working apparatus 10A may further include: a positional information acquisition unit 48 configured to acquire a positional information of the base part 40 in the moving direction. The determining unit 89 may be configured to determine whether the punching operation of the workpiece is completed or not based on the positional information acquired by the positional information acquisition unit 48.

According to this structure, it is possible to easily confirm the time when the punching operation is completed from the positional information of the base part in the advance and retreat direction.

The above press working apparatus 10A may further include: a temperature detector 33 configured to detect a temperature of the workpiece. The press working apparatus 10A may be configured to retreat the pad 50 from the workpiece when the temperature of the workpiece by the temperature detector 33 is lowered to or below a pressure cooling temperature T0.

Moreover, in accordance with the above described embodiments, a press press working apparatus 10A, 10B, 10C in which a heated workpiece is processed may include: a pad 50, 120 configured to move retractably relative to the workpiece to urge the workpiece; a working tool 52, 108, 122 configured to punch the workpiece; and a driving unit 54, 101, 124 configured to drive the working tool 52, 108, 122 along a moving direction of the pad 50, 120 so that the working tool 52, 108, 122 is displaced relative to the pad 50, 120.

According to this structure, since the working tool can be displaced relative to the pad in an advancing direction thereof by the driving unit in a state where the workpiece is urged by the pad, the working tool can punch the workpiece with good precision in a state where the heated workpiece is urged by the pad. Further, since the working tool can be retreated from the workpiece by the driving unit in a state where the workpiece is urged by the pad, it is possible to prevent the working tool from being dragged with the workpiece. By doing so, the damage of the workpiece and the working tool can be avoided, thereby obtaining a processed product with good quality. Further, since the workpiece can be held in a state of being urged by the pad after the working tool is retreated from the punched workpiece, deformation of the workpiece due to a thermal strain can be suppressed so as to obtain a processed product with better quality. If the workpiece is quenched at this time, a processed product may be significantly enhanced.

The above press working apparatus 10A, 10B, 10C may further include: a control unit 84, 114, 126 configured to control the driving unit 54, 101, 124; and a determining unit 89, 128 configured to determine whether a punching operation of the workpiece is completed or not. The control unit 84, 114, 126 may be configured to control the driving unit 54, 101, 124 to cause the working tool to be retreated from the punched workpiece in a state where the workpiece is urged by the pad 50, 120 when it is determined by the determining unit 89, 128 that the punching operation of the workpiece is completed.

According to this structure, since when it is determined by the determining unit that the punching operation of the workpiece is completed, the control unit controls the driving unit to cause the workpiece to be retreated from the punched workpiece in a state where the workpiece is urged by the pad, it is possible to securely prevent the working tool from being dragged with the workpiece.

The above press working apparatus 10A, 10B, 10C may further include

a temperature detector 33 configured to detect a temperature of the workpiece. The press working apparatus 10A, 10B, 100 may be configured to retreat the pad 50, 120 from the workpiece when the temperature of the workpiece by the temperature detector 33 is lowered to or below a pressure cooling temperature T0.

As mentioned above, according to the press working method of the embodiments, since the punching process and the retreating process can be performed before the heated workpiece is cooled to a predetermined temperature, it is possible to prevent the working tool from being dragged with the workpiece even if the workpiece is retracted in the holding process. By doing so, the damage of the workpiece and the working tool can be avoided, thereby obtaining an excellent processed product with good quality.

Further, according to the press working apparatus of the embodiments, since the working tool can be retreated from the workpiece in a state where the workpiece is urged by the pad, it is possible to prevent the working tool from being dragged with the workpiece. By doing so, this press working apparatus has same effect as the press working method.

What is claimed is:

1. A press working method comprising:
preparing a heated workpiece;
punching the heated workpiece using a working tool in a state of urging the workpiece by a pad;
retreating the working tool from the punched workpiece while keeping the state of urging the workpiece by the pad; and
holding the punched workpiece from which the working tool is retreated in a state of being urged by the pad after the retreating of the working tool.

2. The press working method according to claim 1, further comprising:
determining whether the punching is completed or not,
wherein the working tool is retreated from the punched workpiece, when it is determined that the punching is completed.

3. The press working method according to claim 1, further comprising:
executing a press working process of pressing the heated workpiece by the pad before the punching.

4. The press working method according to claim 1, further comprising:
heating the workpiece to a predetermined temperature in the preparing of the heated workpiece;
detecting a temperature of the workpiece in the holding of the punched workpiece; and
retreating the pad from the held workpiece when the detected temperature of the workpiece is lowered to or below a pressure cooling temperature which is lower than said predetermined temperature.

5. A press working apparatus in which a heated workpiece is processed, the apparatus comprising:
a base part configured to move retractably relative to a workpiece;
a pad provided separately from the base part and configured to urge the workpiece;
a working tool provided on the base part and configured to punch the workpiece; and
a connecting unit configured to bias the pad toward the workpiece and extend in a telescopic manner along a moving direction of the base part and in which the connecting unit connects the base part and the pad so that the base part and the pad can be displaced relative to each other along the moving direction of the base part.

6. The press working apparatus according to claim 5, further comprising:
a determining unit configured to determine whether a punching operation of the workpiece is completed or not,
wherein the press working apparatus is configured to retreat the working tool from the workpiece in a state where the workpiece is urged by the pad by expanding the connecting unit when it is determined by the determining unit that the punching operation of the workpiece is completed.

7. The press working apparatus according to claim 6, further comprising:
a base part driving unit configured to drive the base part; and
a base part driving control unit configured to control the base part driving unit,
wherein the determining unit is configured to determine whether the punching operation of the workpiece is completed or not based on a control signal of the base part driving control unit.

8. The press working apparatus according to claim 6, further comprising:
a positional information acquisition unit configured to acquire a positional information of the base part in the moving direction,
wherein the determining unit is configured to determine whether the punching operation of the workpiece is completed or not based on the positional information acquired by the positional information acquisition unit.

9. The press working apparatus according to claim 6, further comprising:
a temperature detector configured to detect a temperature of the workpiece,
wherein the press working apparatus is configured to retreat the pad from the workpiece when the temperature of the workpiece by the temperature detector is lowered to or below a pressure cooling temperature.

10. A press working apparatus in which a heated workpiece is processed, the apparatus comprising:
a pad configured to move retractably relative to the workpiece to urge the workpiece;
a working tool configured to punch the workpiece; and
a driving unit configured to drive the working tool along a moving direction of the pad so that the working tool is displaced relative to the pad.

11. The press working apparatus according to claim 10, further comprising:
a control unit configured to control the driving unit; and
a determining unit configured to determine whether a punching operation of the workpiece is completed or not,
wherein the control unit is configured to control the driving unit to cause the working tool to be retreated from the punched workpiece in a state where the workpiece is urged by the pad when it is determined by the determining unit that the punching operation of the workpiece is completed.

12. The press working apparatus according to claim 11, further comprising:
a temperature detector configured to detect a temperature of the workpiece,
wherein the press working apparatus is configured to retreat the pad from the workpiece when the temperature of the workpiece by the temperature detector is lowered to or below a pressure cooling temperature.
